(19) United States
(12) Patent Application Publication
(10) Pub. No.: US 2005/0037729 A1
(43) Pub. Date: Feb. 17, 2005

(54) Method to automatically monitor a person using a cellular telephone, server and cellular telephone implementing this method

(76) Inventors: Marc Dupont, Dampierre En Braye (FR); Jean-Georges Demathieu, Bourg-La-Reine (FR); Francois Barre, Mont Saint Aignan (FR)

Correspondence Address: RATNERPRESTIA, P O BOX 980, VALLEY FORGE, PA, 19482-0980, US

(21) Appl. No.: 10/641,409

(22) Filed: Aug. 14, 2003

(51) Int. Cl. H04M 11/04; H04Q 7/20

(52) U.S. Cl. 455/404.2; 455/456.1; 455/456.3

(57) ABSTRACT

The invention relates to a method for monitoring a person carrying a cellular telephone through a communication network wherein: An expected path for the monitored person is determined by identifying a sequence of successive places or checkpoints, and A real path followed by the monitored person is detected and compared with the expected path, both in space and in sequence, so that An alert is sent to at least one individual, called alertee, through the communication network when the real path differs from the expected path in place, sequence or in both place and sequence. The invention also relates to a cellular telephone and a server implementing such method.

### BACKGROUND

More and more individuals are interested in localising a person in order to be reassured concerning the whereabouts of this person.

For instance, a minor might have to be localised by one responsible person, e.g. a parent, while an elderly person may have to be similarly localised by one responsible if this elderly person may not find his way back home after having a walk.

Localising a person also presents interest for employers who desire to know where an employee is. This will specially be the case considering a baby sitter, for whom the parents may be looking for at any time, or a company renting cars with chauffeur since employees have to go from on place to another.

According to another example, localising a person presents interest when considering an individual on parole whose movements might be limited to a certain area.

In order to localise a person, methods and devices have been developed, these methods and devices forming roughly two different categories, especially when considering their cost:
A first group comprises special-purpose devices, generally having the form of bracelets or pocket size boxes, which use Global Position System (GPS) technology, i.e. satellite signals.

In that case, the user wearing or carrying such a special-purpose device might require a mobile phone, associated to the GPS device, in order to transmit information regarding his/her location to a responsible person.

These special-purpose devices have very extensive functionality. For instance, they generally can detect if the user has fallen and they cannot be removed or turned off easily.

The present invention results from the finding that these devices present a problem due to their cost since they are relatively expensive. Indeed, such special-purpose devices address a niche market of strongly motivated users which can afford to pay an expensive device, excluding thereby a high number of potential users who are interested in localising someone through low price and/or widely deployed devices.
A second group of devices comprises common telecommunication devices, such as mobile phones.

Indeed, it might be recalled that a mobile phone 100 (FIG. 1) transmits a signal 102 to antennas 104₁, 104₂, 104₃and 104₄ of the communication network 106 so that a server 108, linked with the antennas 104₁, 104₂, 104₃ and 104₄, can analyse the signals and associate the mobile phone 100 to the antenna 104₄ which better covers the area where the mobile phone is located. This way, if a call relates to the mobile phone 100, the server 108 knows to which antenna 104₄ transmit such call.

As a consequence, it appears that it is possible to locate a person 101 through his/her mobile phone 100 by requesting to the server 108 in which area such mobile phone is located.

The invention results also from the finding that the use of a mobile phone to locate a person presents a problem related to the necessity, for the person trying to localise the person 101, to interrogate the system i.e. there is no automatic transmission of information in case of incident.

### SUMMARY OF INVENTION

The present invention relates to a method, a server and a cellular telephone to monitor a person while solving at least one of the herein above indicated problems. It results from a last, but not least, finding that simply locating a person is neither sufficient nor practical for individuals querying about their or someone else's location. In fact, many individuals are rather interested in being alerted by an automated system in case a person is not on an expected path than in being able to query for the location of such person.

For instance, the parents of minors coming back from school are strongly interested by an automatic system which will alert them if their minors deviate from an expected path, e.g. the path from school to home.

Thus, the invention relates to a method for monitoring a person carrying a cellular telephone through a communication network wherein:
An expected path for the monitored person is determined by identifying a sequence of successive places or checkpoints, and
A real path followed by the monitored person is detected and compared with the expected path, both in space and in sequence, so that
An alert is sent to at least one individual, called alertee, through the communication network when the real path differs from the expected path in place, in sequence or in both place and sequence.

This way, a method of monitoring a person according to the invention only needs a commonly used and affordable cellular telephone which would inform automatically an alertee, in charge of the monitored person, only if this monitored person path does not correspond to an expected path in either place or in sequence or in both place and sequence.

To operate this way, an expected path has to be determined, for instance by the monitored person or an authorised person such as the alertee. This expected path (location and sequence) can be programmed in an automated system which monitors the location of the telephone in time.

Indeed, in one embodiment, a time is associated with a checkpoint so that an alert can be sent to the alertee if the monitored device is not located at such checkpoint at its associated time.

Thereby, the system informs the alertee if the monitored person deviates in sequence, in space, in time or in any combination of such parameters.

In one embodiment associating a time with a checkpoint, an acceptable time interval is associated with the checkpoint so that no alert is sent if the monitored person is at the checkpoint at the expected time plus or minus the accepted time interval.

Similarly, in one embodiment, an acceptable area is associated with the time of a checkpoint so that no alert is sent if the monitored person is in this area at such time.

It must be underlined that the invention relates to a cellular telephone which might be a mobile phone or any device, like a Personal Digital Assistant (PDA), having cellular telephone capability i.e. being associated with a cellular communication network such as, and without limitation, a Global System for Mobile (GSM), a Universal Mobile Telecommunications System (UMTS), a Cellular Digital Packet Data (CDPD), a Time Division Multiple Access (TDMA), an iDEN® (Motorola-registered trademark) and/or a Code Division Multiple Access (CDMA) network.

Another advantage of the invention relates on the fact that, as described in detail herein below, the path acquisition can simply be performed by a person without any skilled technical knowledge or without any assistance, for instance by an authorised person like a parent or a minor.

In one embodiment, the whole monitoring method is operated without any assistance, for instance from the cellular network operator, in such a way that the company implementing this method, e.g. through a software, can independently commercialise this method to users.

A method to monitor a person according to the invention presents the inconveniences that, firstly, an expected path must be determined, which requires time, and, secondly, that the monitored person has to comply afterwards with the expected path without being able to change it.

Nevertheless, this new method of monitoring a person brings great advantages when compared with the known methods used to locate a person as previously defined.

Indeed, contrary to special-purpose devices, the new solution relies on a commonly available device, such as a mobile phone, and on an already existing communication network wherein dedicated software(s) can be easily implemented.

Therefore, the overall cost of a method according to the invention is much lower than the method using a special-purpose device.

In addition, the user gets the other benefits associated to cellular telephones (including being able to talk to each other) without needing to carry another device.

Also, a method according to the invention operates the monitoring of a user automatically i.e. it informs the alertee when a difference between the expected path and the real path is detected, whereas prior art methods require the alertee to query for the localisation of the localised person.

Indeed, an alarm is sent automatically to the person(s) in charge of the monitored person in case of deviation in space, in sequence or in both space and sequence from the predefined path.

In other words, a person doing a monitoring according to the invention does not need to care and think for querying the position of the monitored person since he/she will be automatically alerted if the monitored person path differs from the expected path.

In one embodiment, a time is associated with a checkpoint so that an alert is sent to the alertee if the monitored device is not located at such checkpoint at its associated time.

In this case, in one embodiment, an acceptable time interval is associated to the time so that no alert is sent if the monitored person is at the checkpoint at the associated time plus or minus the accepted time interval, such interval being for instance of 30 minutes.

In another embodiment, an acceptable area is associated to the time of the checkpoint so that no alert is sent if the monitored person is in this area at such time.

In one embodiment, the cellular telephone is a mobile phone or a device, like a Personal Digital Assistant (PDA), having cellular telephone capability i.e. being able to communicate through a cellular communication network.

In one embodiment, the communication network uses one of the following technologies: Global System for Mobile (GSM), Universal Mobile Telecommunications System (UMTS), Cellular Digital Packet Data (CDPD), Time Division Multiple Access (TDMA), iDEN®, Code Division Multiple Access (CDMA).

In one embodiment, the alertee is informed through a computer to which a message, as an email, can be sent via the communication network.

In one embodiment, the alertee is informed through a phone having the ability to receive text messages sent via the communication network.

In one embodiment, an automatic voice server informs automatically the alertee through a call generated when the real path differs from the expected path.

In one embodiment, the monitored cellular telephone, a server of the communication network or an alertee telephone comprises administration means, such as hardware and software elements, to perform at least one of the following functions: Authorising and validating a path acquisition, considering different paths recorded for different monitored persons, scheduling on a calendar different paths to be monitored, managing different groups of alertees for different monitored persons, sending a message to the alertee when a difference in localisation and/or in time is detected between the monitored path and the expected path.

In this case, in one embodiment, a managing function is performed either by an authorised person, using a password or other identification method, or by automatic means such as a computer.

Also, it is possible in one embodiment that a managing function is operated by either the monitored cellular telephone or a server of the communication network at different time intervals.

In one embodiment, the expected path is defined by going through the communication network with a cellular telephone recording places successively, such succession corresponding to the sequence.

In one embodiment, the cellular telephone proposes the acquisition of the path on a displayed menu, an administration code being required to identify the user before launching the acquisition.

In this case, in one embodiment, the application gives the possibility to record checkpoint(s) automatically or manually, for instance through the menu of the cellular telephone.

In an embodiment, when the acquisition is operated automatically, the application accommodates for areas of poor or absent antennas by performing repeated localisation attempts over time.

In one embodiment, the expected path is defined through a digital map, for instance via the monitored cellular phone.

In an embodiment, the cellular phone sends directly the alerts to the alertee.

In this case, the cellular telephone might comprise computing means, such as a Java® or other programming environment on the cellular telephone, to memorise the expected path, to compute a location and to compare the expected path with the real path.

In one embodiment, the cellular communication network is used to locate the monitored cellular telephone.

In this case, in one embodiment, a server of the network is used to compute the location of the monitored person by downloading on the cellular telephone the relevant radio network information, including cell identification and location of the cells in the vicinity of the cellular phone.

It is foreseen, in one embodiment, that satellite signals such as GPS signals, are used to locate the monitored cellular telephone.

In one embodiment, a server of the network detects where the cellular telephone is not reachable, e.g. out of range or turned off, so that an alert can be sent to the alertee.

In one embodiment, the cellular telephone and a server of the communication network operate to detect a difference between the expected and the real path.

In an embodiment, a checkpoint is considered as a circular surface, for instance having a radius of 50 meters.

The invention also relates to a cellular telephone for communicating through a network wherein it comprises means, such as hardware and software elements, to operate at least one of the following operations: to acquire an expected path determined by identifying a sequence of successive places or checkpoints, to detect a real path followed by the monitored person carrying the cellular telephone, to compare the real path with the expected path, both in space and in sequence, to send an alert to at least one individual, called alertee, through the communication network when the real path differs from the expected path in place, sequence or in both place and sequence.

The invention also relates to a server of a communication network wherein it comprises means, such as hardware and software elements, to operate at least one of the following operations: to acquire an expected path determined by identifying a sequence of successive places or checkpoints, to detect a real path followed by the monitored person carrying the cellular telephone, to compare the real path with the expected path, both in space and in sequence, to send an alert to at least one individual, called alertee, through the communication network when the real path differs from the expected path in place, sequence or in both place and sequence.

Other features and advantages of the invention will appear with the following description of its preferred embodiments, this description being made with reference to the herein appended drawings wherein:

### BRIEF DESCRIPTION OF THE DRAWINGS

FIG. 1, already described, is a diagram representing the operation of a mobile phone network, and

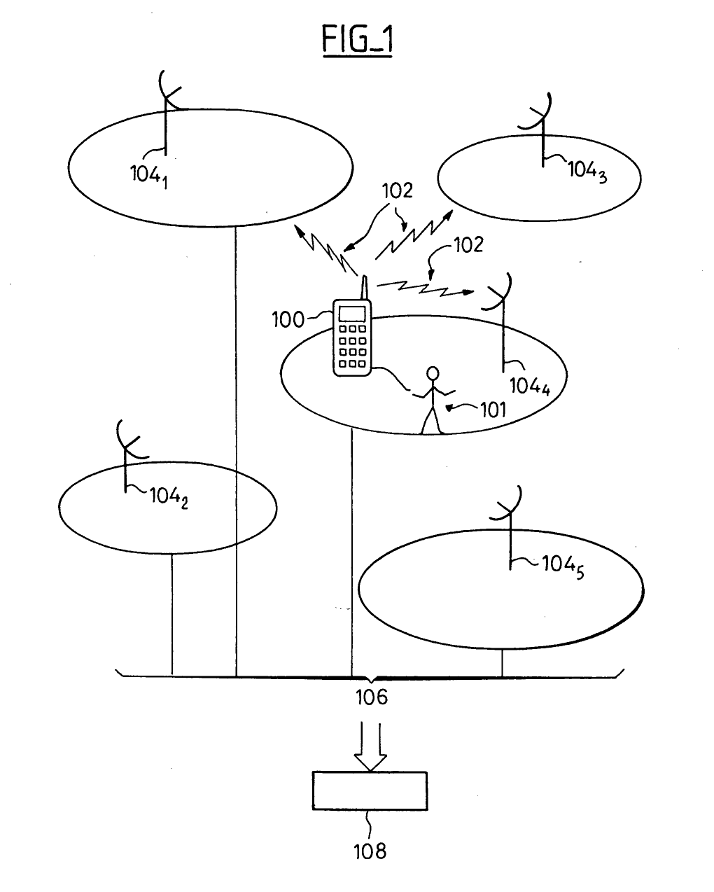

FIG. 2 is a diagram representing elements used to implement different embodiments of the invention.

### DETAILED DESCRIPTION

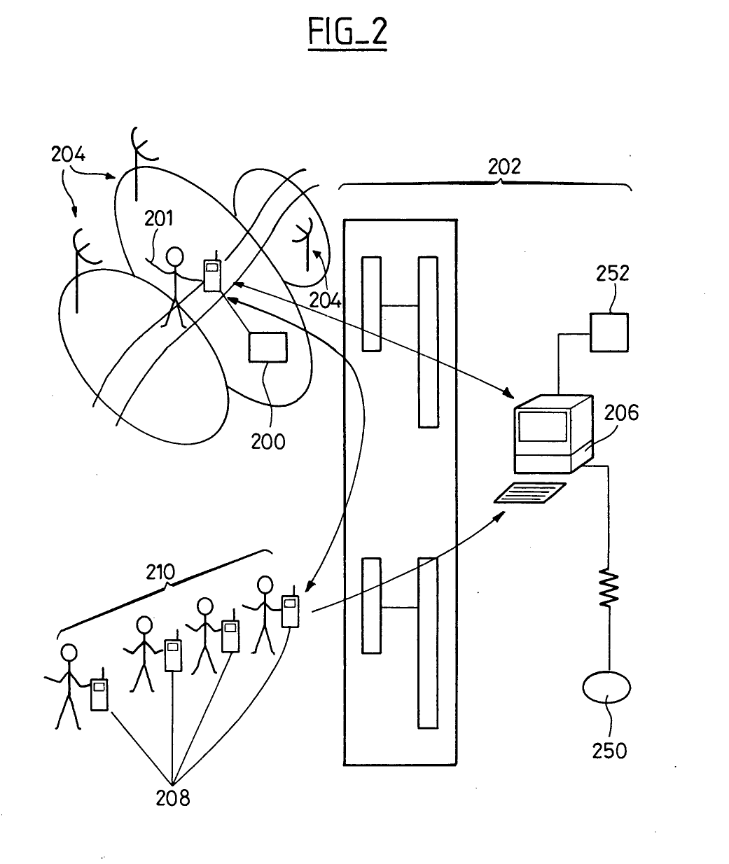

Three preferred embodiments of the invention will herein below be described in reference to the same FIG. 2 representing common features to such embodiments, namely:
A cellular telephone 200, such as a mobile phone or any device like a Personal Digital Assistant (PDA) having cellular telephone capability i.e. being able to communicate through a cellular communication network.

The cellular telephone 200 is carried by the monitored person 201 in order to allow his/her monitoring through a communication network 202 which transmits communications relating to the cellular telephone 200.
Antennas 204 and means, such as a server 206, which allow the monitoring of the cellular telephone 200 as described herein below.

At this level, it might be underlined that the server 206 function in the monitoring varies depending on the embodiment of the invention. Indeed, in one embodiment, such server is not necessary.
The telephones 208 of the alertees 210 which is used to inform the alertees 210 that the monitored person 201 does not follow the predetermined or expected path in location, in sequence or in both location and sequence.

Also, in other embodiments, the device used by the alertees 210 may differ from a telephone. Indeed, the device could be a computer to which a message, such as an email, would be sent through the communication network 202 if such computer and network are connected, for instance through the Internet.

In this embodiment, all phones 208 have the ability to receive text messages in order to be alerted through such text messages in case the monitored person 201 follows a real path which differs from the expected or predetermined path.

Otherwise, alertees 210 may be informed by a call operated by an automatic voice server providing the necessary information through a call, such necessary information comprising, in these embodiments, the difference between expected path and the real path.

The three embodiments described herein below require, previously to the monitoring of a person, the acquisition and recording of the parameters necessary to define a predetermined or expected path, in location, sequence and optionally duration.

Such an acquisition is described herein bellow within each embodiment, wherein a path can be described by a start checkpoint and an end checkpoint, interval checkpoints being optional.

At this level, it might be underlined that the place defining a checkpoint corresponds, in these embodiments, to a surface practically corresponding to a circular area having a radius of 50 meters.

Also, to conclude the path definition, the sequence of checkpoints is defined in these embodiments by considering that, at specified times within specified intervals, the monitored cellular telephone must be at a certain checkpoint.

In other words, the sequence associated to the expected path corresponds to the order in which the checkpoints are encountered

To manage the method, administration means must be operated to perform the following functions:
Authorising and validating a path acquisition,
Considering different paths recorded for different monitored persons 201. Some features of this management might be the listing of paths and/or zones and the possibility of removing paths and/or zones.
Scheduling on a calendar the different paths to be monitored. Several alternate paths may be scheduled at the same time, with automated or manual selection of one or another path. These may correspond for example to two ways to go to school on foot or by bus.
Managing different groups of alertees for different monitored persons. Such management may include adding, removing, listing phone numbers.
Sending a message to alertees when a difference in localisation and/or in time is detected between the monitored path and the expected path.

Each operation herein above referenced is performed either by an authorised person, using a password or other identification method, or by automatic means such as a computer.

Based on the previously described common features, three preferred embodiments of the method to monitor a person according to the invention are described in accordance with the FIG. 2, the goal of such embodiments being similar in all cases i.e. to detect any anomaly in position, in sequence or in both position and sequence of the monitored person 201 during his/her real path compared to a predetermined or expected path so that an alert can be sent to alertees 201 if such paths differ.

The first preferred embodiment of the invention is called ‘client centric implementation’. In this case, two ways of doing the path acquisition can be used, namely the path acquisition on the ground and the path acquisition through a map:
The path acquisition on the ground requires a device, such as the monitored cellular telephone 202, to go through the communication network in order to record places successively, such succession corresponding to the sequence while the places correspond to the checkpoints.

To operate this acquisition on the ground, the cellular telephone comprises means to propose such acquisition on a displayed menu, in which case an administration code might be required to identify the user before launching the application of ground acquisition.

Once such application is launched, the monitored person starts, from a starting point 210 of the path, the recording of the path through a menu command displayed on the cellular telephone.

The application may give the possibility to force the recording of checkpoint(s) manually, for instance through the menu of the cellular telephone.

Also, the application may accommodate for areas of poor or absent antennas by performing repeated localisation attempts over time.

At the end of the path, the monitored person stops the recording through a menu command displayed on the cellular phone. The path recorded is stored on the cellular telephone 200.

This method of path recording is simple and relies only on commonly available cell phones, and can therefore be followed by most people today.
The path acquisition on a map requires access to mapping means allowing the drawing of a path on a digital map. In these embodiments, such means are in the monitored cellular phone 200.

Once the path acquisition has been operated, the path monitoring can be done without communication with any application server 206 of the communication network, in which case the cellular phone 200 sends alerts to alertees directly.

For that purpose, the cellular telephone 200 comprises computing means, such as a Java® or other programming environment on the terminal or its SIM card, which allows to memorise an expected path, to compute a location, for instance using GPS signals or the cellular network, and to compare the expected path with the real path.

In the case the cellular network is used to get located, the server 206 may be used to compute the location of the monitored person by downloading on the cellular telephone the relevant radio network information, including cell identification and location of the cells in the vicinity of the cellular phone.

In the case of GPS location on the cell phone, the role of the server 206 is therefore limited to detecting cases where the cellular telephone is not reachable (e.g. out of range or turned off), so an alert can be sent to alertees.

In this case, the server 206 can also be avoided by implementing an application in the alertees' phones which detects the cases where the cellular telephone 200 is not reachable during scheduled monitoring.

This first embodiment minimizes the volume of communication needed to implement the method. However, it uses computing and storing means on the cellular telephone or its SIM card, hence reducing its battery life.

According to the second preferred embodiment, called ‘balanced implementation’, the path acquisition can also be done through a path acquisition on the ground in a similar way as described for the first embodiment, except that in this case the recorded path is stored either on a server 206 or on the cellular phone 200.

Similarly, path acquisition on a map can be operated using the cellular telephone or another device 250, e.g. a P.D.A. or a computer, connected to the server 206.

In these cases, a mapping application converts the path drawing to a format that uses actual location coordinates for use in the monitoring phase.

Such monitoring is done in this second preferred embodiment through a dient-server architecture where the cellular telephone 200 is the client and the server 206 of the communication network is the server.

Thus, the server 206 alerts the alertees 208 in case the monitoring detects any difference between the expected path and the operated path.

The operated or real path can be determined through GSM signals, since the cellular phone is connected to ta database of the communication network which computes the cellular telephone location based on information transmitted from the cellular telephone 200.

The cellular telephone 200 may continue to use any of the methods described in the first embodiment to detect exit of path cases. For instance, the cellular telephone 200 and the server 206 may both perform detection of exit of path at different time intervals, which helps reduce battery usage and communication load.

In the case of location through GPS or A-GPS, the server 206 can also perform some of the computation (GPS computations, or assistance to GPS), thereby reducing battery usage and phone cost.

Finally, it is important to note that it is the server 206 which sends alerts to the alertees, in any format, including text messages, graphical messages or voice messages.

In this second preferred embodiment, the administration is operated by either the cellular telephone 200 or the server 206.

If such administration is operated by the server, the server might be helped by any device connected to it, such as means 252, after authentication of this means through the use of an administrative code or other authentication mechanism.

In the third preferred embodiment, called ‘server-centric implementation’, the two already described ways for performing the Path Acquisition can be operated, namely:
The path acquisition on the ground, which operates as for the first embodiment except that the recorded path is stored on the server 206.
The path acquisition on a map, wherein the alertees can define the path by drawing it on a map, using either his/her cellular telephone, a computer 252 and/or any other mean connected to the server 206. The mapping application converts the path drawn to a format that uses actual location coordinates for use in the monitoring phase.

In this third embodiment, path monitoring could be done as follows: In the case of location through GSM, all location computations and monitoring is done by the server 206.

The cellular telephone 200 may contribute to the gathering of location information, like cell identification, timing advance, network measurement results or all information which may be gathered from the network without active involvement of the monitored person 201.

This solution may be the easiest to implement for operators who have already deployed network-based location solutions.

The server 206 can send alerts in any format, including text messages, graphical messages or voice messages.

It should be noted that an administration code is used to prevent use of the application by unauthorized people. Other authentication mechanisms can also be used instead (for example confirmation from the alertees 210).

In this third embodiment, administration functionality resides on server 206, but such administration can remotely be shared with any device 252 connected to such server 206, after authentication through the use of the administration code or other authentication mechanism.

Other embodiments of the invention can be developed within the scope of the invention. For instance, in one embodiment, the monitored person is an alertee so that, if his/her path differs from the predetermined path, he/she is alerted in order to correct his/her path.

In other embodiment, the path can include periods of time where the person monitored could be anywhere in one area of the path i.e. the monitored person does not have to go from one checkpoint to another in a specified sequence or time.

Finally, it is important to notice that the invention can simply be implemented in existing cellular telephones and communication networks using software applications for performing the different operations required by the invention.

1. A method for monitoring a person carrying a cellular telephone through a communication network wherein:
An expected path for the monitored person is determined by identifying a sequence of successive places or checkpoints, and
A real path followed by the monitored person is detected and compared with the expected path, both in space and in sequence, so that
An alert is sent to at least one individual, called alertee, through the communication network when the real path differs from the expected path in place, sequence or in both place and sequence.

2. A method according to claim 1 wherein a time is associated with a checkpoint so that an alert is sent to the alertee if the monitored device is not located at such checkpoint at its associated time.

3. A method according to claim 2 wherein an acceptable time interval is associated to the time so that no alert is sent if the monitored person is at the checkpoint at the associated time plus or minus the accepted time interval, such interval being for instance of 30 minutes.

4. A method according to claim 1 wherein an acceptable area is associated to the time of the checkpoint so that no alert is sent if the monitored person is in this area at such time.

5. A method according to claim 1 wherein the cellular telephone is a mobile phone or a device, like a Personal Digital Assistant (PDA), having cellular telephone capability i.e. being able to communicate through a cellular communication network.

6. A method according to claim 1 wherein the communication network uses one of the following technologies: Global System for Mobile (GSM), Universal Mobile Telecommunications System (UMTS), Cellular Digital Packet Data (CDPD), Time Division Multiple Access (TDMA), iDEN®, Code Division Multiple Access (CDMA).

7. A method according to claim 1 wherein the alertee is informed through a computer to which a message, as an email, can be sent via the communication network.

8. A method according to claim 1 wherein the alertee is informed through a phone having the ability to receive text messages sent via the communication network.

9. A method according to claim 1 wherein an automatic voice server informs automatically the alertee through a call generated when the real path differs from the expected path.

10. A method according to claim 1 wherein the monitored cellular telephone, a server of the communication network or an alertee telephone comprises administration means to perform at least one of the following functions: Authorising and validating a path acquisition, considering different paths recorded for different monitored persons, scheduling on a calendar different paths to be monitored, managing different groups of alertees for different monitored persons, sending a message to the alertee when a difference in localisation and/or in time is detected between the monitored path and the expected path.

11. A method according to claim 10 wherein a managing function is performed either by an authorised person, using a password or other identification method, or by automatic means such as a computer.

12. A method according to claim 10 wherein a managing function is operated by either the monitored cellular telephone or a server of the communication network at different time intervals.

13. A method according to claim 1 wherein the expected path is defined by going through the communication network with a cellular telephone recording places successively, such succession corresponding to the sequence.

14. A method according to claim 13 wherein the cellular telephone proposes the acquisition of the path on a displayed menu, an administration code being required to identify the user before launching the acquisition.

15. A method according to claim 13 wherein the application gives the possibility to record checkpoint(s) automatically or manually, for instance through the menu of the cellular telephone.

16. A method according to claim 15 wherein, when the acquisition is operated automatically, the application accommodates for areas of poor or absent antennas by performing repeated localisation attempts over time.

17. A method according to claim 1 wherein the expected path is defined through a digital map, for instance via the monitored cellular phone.

18. A method according to claim 1 wherein the cellular phone sends directly the alerts to the alertee.

19. A method according to claim 18 wherein the cellular telephone comprises computing means, such as a lava® or other programming environment on the cellular telephone, to memorise the expected path, to compute a location and to compare the expected path with the real path.

20. A method according to claim 1 wherein the cellular communication network is used to locate the monitored cellular telephone.

21. A method according to claim 20 wherein a server of the network is used to compute the location of the monitored person by downloading on the cellular telephone the relevant radio network information, including cell identification and location of the cells in the vicinity of the cellular phone.

22. A method according to claim 1 wherein satellite signals such as GPS signals, are used to locate the monitored cellular telephone.

23. A method according to claim 22 wherein a server of the network detects where the cellular telephone is not reachable, e.g. Out of range or turned off, so that an alert can be sent to the alertee.

24. A method according to claim 1 wherein the cellular telephone and a server of the communication network operate to detect a difference between the expected and the real path.

25. A method according to claim 1 wherein a checkpoint is considered as a circular surface, for instance having a radius of 50 meters.

26. A cellular telephone for communicating through a network wherein it comprises a processor to operate at least one of the following operations: to acquire an expected path determined by identifying a sequence of successive places or checkpoints, to detect a real path followed by the monitored person carrying the cellular telephone, to compare the real path with the expected path, both in space and in sequence, to send an alert to at least one individual, called alertee, through the communication network when the real path differs from the expected path in place, sequence or in both place and sequence.

27. A server of a communication network wherein it comprises a processor to operate at least one of the following operations: to acquire an expected path determined by identifying a sequence of successive places or checkpoints, to detect a real path followed by the monitored person carrying the cellular telephone, to compare the real path with the expected path, both in space and in sequence, to send an alert to at least one individual, called alertee, through the communication network when the real path differs from the expected path in place, sequence or in both place and sequence.
